(19) United States
(12) Patent Application Publication
(10) Pub. No.: US 2006/0256446 A1
(43) Pub. Date: Nov. 16, 2006

(54) Optical collimator

(76) Inventors: Hirokazu Tanaka, Shiga-Ken (JP); Nobuo Funabiki, Shiga-Ken (JP)

Correspondence Address: J C Patents Inc, Suite 250, 4 Venture, Irvine, CA, 92618, US

(21) Appl. No.: 10/549,756

(22) PCT Filed: Mar. 22, 2004
(86) PCT No.: PCT/JP04/03840

§ 371 Date: May 15, 2006

(30) Foreign Application Priority Data
Mar. 20, 2003 (JP) 2003-077487

(51) Int. Cl. G02B 27/30

(52) U.S. Cl. 359/641

(57) ABSTRACT

An optical collimator 21 includes a glass-made partially spherical lens 23 having translucent spherical surfaces 23b with approximately the same center of curvature at both ends of a columnar portion 23a, a glass-made or crystallized glass-made capillary tube 24 holding an optical fiber 25 with an angled end face 25a at a center, and a glass-made or crystallized glass-made cylindrical eccentric sleeve 22 having an inner hole 22a for fixing the partially spherical lens 23 and the capillary tube 24 therein. An optical axis Z of collimated beam 27 is in a round with radius range of 0.02 mm or less, and is in an angle range of 0.2° or less with respect to the center axis B of the outer surface of the eccentric sleeve 22.

### TECHNICAL FIELD

The present invention relates to an optical collimator that uses a capillary tube holding an optical fiber for optical communications at a center, a partially spherical lens obtained by working a spherical lens into a columnar shape, and an eccentric sleeve aligning the axes of the optical fiber in the capillary tube and the partially spherical lens with each other.

### BACKGROUND ART

When a high-speed and large-capacity optical fiber communications system is constructed, many optical devices are used for the system. Some of them include optical devices that extract an optical signal having an arbitrary wavelength from among multiple optical signals, which have multiplexed wavelengths, and optical devices that use an optical crystal for matching phases of optical signals. And many optical collimators are used therein which each convert a widening optical signal emitted from an optical fiber into collimated beam or condense collimated beam onto the optical fiber.

Alternatively, optical collimators may be used for various sensors. For example, a system for detecting an optical pulse of a rotary encoder or the like that is attached to a rotation axis and detects a rotation of the axis.

As shown in FIG. 9, a conventional optical collimator 1 using a partially spherical lens 3 is assembled by inserting the partially spherical lens 3 and a concentric capillary tube 4 holding an optical fiber 5 and having an angled polished surface 4a for prevention of reflection signal from an end face 5a of the optical fiber 5 into an inner hole 2a of a concentric sleeve 2, aligning them so that they are at optically appropriate position and the optical collimator 1 perform correctly, and bonding them using an adhesive 6.

Patent Document 1 that is a prior art document concerning such an optical system discloses a method with which eccentricity of collimated beam entering/outgoing with respect to the center axis of an optical collimator that uses a partially spherical lens is eliminated using an angled polished optical element. Patent Document 2 discloses a collimator, in which the optical axis of a beam outgoing from a lens is parallel to the optical axis of an optical fiber, and Patent Document 3 discloses an optical fiber collimator in which the optical axis of an optical fiber is decentered with respect to the center of a lens and the center of the lens and the center of a light beam entering the lens are brought into approximate coincidence with each other. Further, Patent Document 4 discloses an optical connector in which the center of a tubular housing is defined as the centerline of a collimated beam emitted through a spherical lens. Still further, Patent Document 5 discloses an optical collimator, which achieves parallel beam coupling by giving translation deviations to the center axes of an optical fiber and the center axes of a lens in accordance with the polished angle of a optical fiber end face.
[Patent Document 1] JP 2001-56418 A
[Patent Document 2] JP 05-157992 A
[Patent Document 3] JP 2002-196180 A
[Patent Document 4] JP 02-111904 A
[Patent Document 5] JP 62-235909 A

In the conventional structures described above, the concentric sleeve 2 is used, so when the concentric capillary tube 4 holding the optical fiber 5 and having the angled polished surface 4a for the prevention of the reflection optical signal from the end face 5a is used as shown in FIG. 9, light is emitted from the end face 5a of the optical fiber 5 in accordance with a law of refraction in an inclined direction with respect to the center axis A of the optical collimator 1. As a result, there is a problem in that eccentricity δ occurs between the optical axis Z of collimated beam 7 emitted from the optical collimator 1 and the center axis A of the optical collimator 1.

Also, when an optical function component 8 is assembled using optical collimators 1 having the conventional structure and an optical function element 8a as shown in FIG. 10, collimated beam 7 is decentered with respect to the center axes A of the optical collimators 1, so it is required to bring the decentered directions of the optical collimators 1 into coincidence with each other with precision, which leads to a problem in that workability of assembly is significantly lowered.

Further, when it is attempted to solve the problems using a concentric capillary tube 14, wherein the concentric capillary tube 14 holds an optical fiber 15 and an end face 14a of the concentric capillary tube 14 is not angled polished, and a concentric sleeve 12 so that collimated beam 17 enters/outgoes from the center axis A of an optical collimator 11 as shown in FIG. 11, it becomes impossible to achieve a desired return loss due to angled polishing. Thus, reflection optical signal from an end face 15a of the optical fiber 15 and translucent spherical surfaces 13b of a partially spherical lens 13 becomes extremely large, which makes it impossible to sufficiently prevent reflection optical signal even when an antirefelection coating is applied to each surface. This reflection optical signal exerts an adverse influence on a laser light source and the like and therefore becomes a significant practical problem when a high-speed and large-capacity optical fiber communications system is constructed.

Also, even with the method disclosed in Patent Document 1, when the angled polished optical element, both end face of which are angled polished parallel to each other (page 5, FIG. 1), is used, aligning work needs to be performed with precision so that collimated beam enters/outgoes with respect to the center axis of the optical collimator, which significantly lowers workability. Also, the angled polished optical element is inserted into an optical path, so an insertion loss of the optical collimator is increased and when a high-speed and large-capacity optical fiber communications system is constructed, this increased insertion loss becomes a problem.

Further, also when an off-axis cylindrical holder produced through cutting of a metal or the like, inner hole center and outer surface center of the holder being displaced from each other, is used (page 7, FIG. 9), there is also a shortcoming that precise working is required through which the outer surface center and the inner hole center are set to be slightly displaced from each other. Also, there exist differences in coefficient of thermal expansion among the metal-made off-axis cylindrical holder, the capillary tube holding the optical fiber, and the partially spherical lens. When the differences are large, it is concerned that optical properties will go wrong, because of differences in amount of expansion or shrinkage among the respective construction elements due to changing of a temperature at the time of use. In particular, when stress is concentrated on the partially spherical lens due to occurrence of such expansion differences, the number of troubles ascribable to the wrongness of the optical properties, such as a refractive index and dispersion, is increased, which leads to a problem with stability of the optical system.

Therefore, under a high-temperature or low-temperature condition, which greatly differs from room temperature, exfoliation occurs to bonding portions of the sleeve, the capillary tube, and the partially spherical lens, which incurs inconvenience such as impairment of essential component properties, changing of a transmission light amount due to occurrence of distortion to the partially spherical lens, changing of a polarization properties, and unstable collimated beam. As a result, the use environment of the optical communications device of this type is limited; in particular, the outdoor use of the optical communications device is significantly limited. In addition, fine optical properties are required in the case of incorporation into an optical device, so a usable temperature range becomes extremely narrow and there occurs a problem in that limitations at the time of use become more severe.

Also, as disclosed in Patent Document 2, the beam emitted from the lens is parallel to the axis of an input-side mount, but they do not coincide with each other and the beam merely becomes a collimated beam having a certain distance from the axis of the input-sidemount (page 5, FIG. 3), so it is necessary to align optical collimators with each other while performing rotation about the axis of the mount.

Also, with the method disclosed in Patent Document 3, the optical fiber collimator is constructed by decentering the optical axis of the optical fiber with respect to the center of the refractive-index-distribution-type rod lens so that the center of the refractive-index-distribution-type rod lens and the center of the light beam entering the lens approximately coincide with each other (page 5, FIG. 1). But when a spherical lens is used in place of the refractive-index-distribution-type rod lens, the optical axis of the optical fiber is decentered with respect to the center of the lens, so the emitted light beam does not coincide with the optical axis of the optical fiber.

Also, as disclosed in Patent Document 4, the core centerline of the optical fiber and the optical axis of the light beam do not coincide with each other (page 6, FIG. 2), so it is required to machine-work the tubular housing while keeping the optical axis of the light beam and a machine axis coincident with each other using a photodetector or the like (page 6, FIG. 3). Also, when a spherical lens having a plane with desired dimensions is used (page 6, FIG. 4), it is required to strictly align an angle between the plane and the optical axis of the beam emitted from the optical fiber at the time of assembling.

Also, in the disclosure in Patent Document 5 in which the parallel beam coupling is achieved in the optical collimator by giving the translation deviations to the center axes of the optical fiber and the lens in accordance with the angled polished angle of the optical fiber end face (page 4, FIG. 1), the optical axis of the emitted parallel beam does not coincide with the center axis of the optical fiber, so work for aligning the optical collimators with each other requires a great deal of labor.

Further, when the work for aligning the conventional optical collimators 1 with each other is conducted, eccentricity 5 occurs between the center axes A of the optical collimators 1 and the optical axis Z of the collimated beam 7. Thus, for instance, even in the case where the optical collimators 1 are placed to oppose each other on one precise V-groove at positions, at which their working distance is secured, and under a state, in which the center axes B of the outer surfaces of the sleeves 2 coincide with each other, when light is introduced from the optical fiber 5 on one side, it is impossible to obtain a sufficient optical response from the optical fiber 5 on the other side. It is, therefore, required to manually conduct aligning work until a state is obtained in which it is possible to obtain a sufficient optical response and use an optical axis self-aligning apparatus or the like.

Also, in the case of an optical collimator is made by metal components and when the optical collimator is used in a high magnetic field of 1 Tesla or more, that is, 10000 Gauss or more, it is concerned that the metallic component may be broken because an influence of electromagnetic induction is exerted and a strong eddy current flows through the metal. Further, the metallic component itself receives an attractive force from the high magnetic field and distortion occurs to the shape of the metallic component due to internal stress, which makes it difficult to maintain optical properties of the optical collimator.

### DISCLOSURE OF THE INVENTION

An object of the present invention is to provide an optical collimator in which it is not necessary to conduct aligning work for coincidence of decentered directions of entering/outgoing collimated beam with each other at the time of assembling of an optical function component or the like, as in the case of a conventional optical collimator using a concentric sleeve, and allows collimated beam to enter/outgo with respect to the center axis of the optical collimator.

Another object of the present invention is to provide an optical collimator that can reduce degradation of optical properties ascribable to differences in coefficient of thermal expansion among an eccentric sleeve, a partially spherical lens, and a capillary tube at the time of use under various temperature conditions as much as possible and is not adversely influenced by electromagnetic induction even in a high magnetic field of 1 Tesla or more.

An optical collimator according to the present invention includes: a cylindrical eccentric sleeve; a partially spherical lens having a columnar portion fixed into the eccentric sleeve and translucent spherical surfaces with approximately the same center of curvature at both ends of the columnar portion; and a capillary tube fixed into the eccentric sleeve, holding an optical fiber at a center, and having an angled end face directed toward the partially spherical lens, wherein the eccentric sleeve is made of glass or crystallized glass.

When an eccentric sleeve used for an optical collimator is made of a metal, significant expansion/shrinkage occurs with respect to changing of an ambient temperature and an optical path length changes accordingly, so it becomes impossible to obtain stable optical performance. Also, in order to produce a high-precision metal-made eccentric sleeve, it is required to conduct grinding work with accuracy of the order of micrometers on each sleeve using a precision cylindrical grinding machine or the like, which is problematic in terms of supply capacity and manufacturing cost. Further, in recent years, with the advancement of miniaturization/high-density packaging of optical devices used in optical communications, compact optical collimators are required more greatly. In reality, however, production itself of compact and high-precision metal-made eccentric sleeves used for optical communications devices using single-mode optical fibers or the like is almost impossible. As to the eccentric sleeve used for the optical collimator according to the present invention, it is important that an eccentric sleeve that is compact and highly precise as compared with a conventional case can be forming continuously with accuracy and is made of glass or crystallized glass that is advantageous in terms of supply capacity and manufacturing cost.

More specifically, as shown in FIG. 1(A), (B), an optical collimator 21 includes a partially spherical lens 23 having translucent spherical surfaces 23b with approximately the same center of curvature at both ends of a columnar portion 23a made of glass having an approximately uniform refractive index, a capillary tube 24 holding an optical fiber 25 with an angled end face 25a at a center, and a cylindrical eccentric sleeve 22 made of glass or crystallized glass and having an inner hole 22a that is slightly larger than the diameter of the partially spherical lens 23 and the outer diameter of the capillary tube 24 that are approximately vertical to an optical axis. Where, it is preferable that an optical axis Z of collimated beam 27 entering/outgoing from the translucent spherical surface 23b of the partially spherical lens 23 is in a round with radius range of 0.02 mm or less, the center of the round being set at the center axis B of the outer surface of the eccentric sleeve 22, and is in an angle range of 0.2° or less with respect to the center axis D of the outer surface of the eccentric sleeve 22.

Further, in the optical collimator 21 according to the present invention, when one pair of the optical collimators are arranged to oppose each other at positions, at which a working distance thereof is secured, and under a state, in which the center axes of the outer surfaces of the eccentric sleeves coincide with each other, and when optical signal is introduced from the optical fiber on one side, an optical signal response of −30 dB or more is obtained with respect to an input from the optical fiber on the other side.

The optical collimator 21 according to the present invention shown in FIG. 1 is produced by inserting the partially spherical lens 23 shown in FIG. 3 having the translucent spherical surfaces 23b with approximately the same center of curvature at both end faces of the columnar portion 23a made of glass having an approximately uniform refractive index, and the concentric capillary tube 24 shown in FIG. 2 holding the optical fiber 25, into the inner hole 22a of the eccentric sleeve 22 shown in FIG. 4 decentered in advance so that the collimated beam 27 will not be decentered with respect to the center axis A of the optical collimator 21, and then by fixing them at optically appropriate positions so that the optical collimator 21 perform correctly. Where, incidence/emission is possible at an angle of 0.2° or less from a range in which the optical axis Z of the collimated beam 27 is in a round with radius range of 0.02 mm or less with respect to the center axis B of the outer surface of the eccentric sleeve.

As shown in FIG. 2, the optical fiber 25 is fixed onto the center axis Y of the outer surface of the concentric capillary tube 24 constituting the optical collimator 21 according to the present invention. Thus, when the partially spherical lens 23 shown in FIG. 3 and the concentric capillary tube 24 holding the optical fiber 25 are fixed in the inner hole 22a of the eccentric sleeve 22 shown in FIG. 4, wherein the center axis B of the outer surface and the center axis C of the inner hole 22a of the eccentric sleeve 22 are displaced from each other by δ in advance so that the optical axis Z of the collimated beam 27 will not be decentered with respect to the center axis A of the optical collimator 21, at optically appropriate positions so that the optical collimator 21 perform correctly, it becomes possible to obtain the optical collimator 21 with which as shown in FIG. 1, the collimated beam 27 enters/outgoes from the center axis A of the optical collimator 21.

Also, as shown in FIG. 3, the partially spherical lens 23 constituting the optical collimator 21 according to the present invention has the translucent spherical surfaces 23b, which have approximately the same center of curvature and are applied with an tire election coating, at both ends of the columnar portion 23a made of glass having an approximately uniform refractive index. In addition, the center axis X of the outer surface of the partially spherical lens 23 becomes the optical axis.

In contrast to this, when the optical collimator 1 is assembled by inserting the partially spherical lens 3 the optical axis of which exists at the center axis X of the outer surface, and the concentric capillary tube 4 holding the optical fiber 5 into the inner hole 2a of the concentric sleeve 2 as shown in FIG. 9 described above, the collimated beam 7 does not enter/outgo from the center axis A of the optical collimator 1.

As the partially spherical lens 23 used in the present invention, it is possible to use materials that can produce a spherical lens having high focus accuracy through working into a perfect spherical shape, so long as they are made of optical glass or the like having approximately uniform refractive index. The partially spherical lens 23 produced by grinding the periphery of a spherical lens having high sphericity is suitable in terms of miniaturization and diameter reduction of the optical collimator 21. As the glass used for the partially spherical lens 23, optical glass, such as BK7, K3, TaF3, LaF01, or LaSF015, is preferable.

Also, the eccentric sleeve 22 used in the present invention, wherein the center axis B of the outer surface and the center axis C of the inner hole of the of the sleeve 22 are displaced from each other by δ in advance as shown in FIG. 4 so that the optical axis Z of the collimated beam 27 will not be decentered with respect to the center axis A of the optical collimator 21, is made of glass or crystallized glass and can be produced with high accuracy, with stability, with efficiency, and at low cost using a drawing process. Further, the eccentric sleeve 22 is produced using the drawing process with which softened glass is drawn, so the surface of the eccentric sleeve is fire-polished.

When it is assumed that the coefficient of thermal expansion of the partially spherical lens 23 made of optical glass “LaSF015” constituting the optical collimator 21 shown in FIG. 1 is 74×10⁻⁷/K, the coefficient of thermal expansion of the sleeve 22 made of borosilicate glass is 51×10⁻⁷/k, and the coefficient of thermal expansion of the capillary tube 24 made of crystallized glass is 27×10⁻⁷/K, when environmental temperature varies by 60° C., changing of the eccentricity amount δ of the optical axis Z of the collimated beam 27 with respect to the center axis A of the optical collimator 21 ascribable to mutual differences in coefficient of thermal expansion becomes 0.0003 mm (0.3 μm) or less. Also, changing of the outgoing deviation angle of the collimated beam 27 (beam inclination angle) is 0.01° or less.

On the other hand, when a general stainless steel SUS304, which has coefficient of thermal expansion is 184×10⁻⁷/K, is used for the eccentric sleeve 22, the mutual differences in coefficient of thermal expansion become 100×10⁻⁷/K or more, changing of the eccentricity amount of the optical axis Z of the collimated beam 27 with respect to the center axis A of the optical collimator 11 ascribable to the differences becomes around 0.0009 mm (0.9 μm), and changing of the outgoing deviation angle of the collimated beam 27 (beam inclination angle) becomes around 0.03° , which are inferior results in which the values are approximately tripled as compared with the case of the sleeve 22 made of borosilicate glass is used.

Therefore, in order to produce the optical collimator 21 having stable optical properties with respect to changing of environmental temperature, it is important to produce the optical collimator using materials, mutual differences in coefficient of thermal expansion of which are 50×10⁻⁷/K or less.

Also, the optical collimator 21 according to the present invention is produced using the partially spherical lens, the capillary tube, and the eccentric sleeve made of glass or crystallized glass as an electrically insulating material and is characterized in that substantially no eddy current is generated due to electromagnetic induction in a high magnetic field of 1 Tesla or more.

When a martensitic stainless steel SUS410 or ferritic stainless steel SUS430 is used as the eccentric sleeve 22 in a high magnetic field of 1 Tesla or more, that is, 10000 Gauss or more, it is concerned that an influence of electromagnetic induction will be exerted, a strong eddy current will flow through the eccentric sleeve 22, and the eccentric sleeve 22 may be broken. In addition, the eccentric sleeve 22 itself receives an attractive force from the high magnetic field, so it is concerned that distortion will occur to the shape of the eccentric sleeve 22 due to stress and it will be come difficult to maintain optical properties of the optical collimator. Therefore, it is important that the partially spherical lens 23, the capillary tube 24, and the eccentric sleeve 22 made of glass or crystallized glass as an electrically insulating material that are not influenced by electromagnetic induction, such as an eddy current, even in a high magnetic field of 1 Tesla or more, that is, 10000 Gauss or more are used for the optical collimator 21 according to the present invention.

The optical collimator according to the present invention includes the cylindrical eccentric sleeve, the partially spherical lens having the columnar portion fixed into the eccentric sleeve and translucent spherical surfaces with approximately the same center of curvature at both ends of the columnar portion, and the capillary tube fixed into the eccentric sleeve, holding an optical fiber at a center, and having an angled end face toward the partially spherical lens, wherein the eccentric sleeve is made of glass or crystallized glass, so at the time of production of an small size optical collimator, it becomes possible to use a precision processing technique for glass, which makes it possible to obtain an eccentric sleeve that is highly precise and inexpensive as compared with a metal-made eccentric sleeve and realize an unprecedented optical collimator that is small and is implementable at a high density.

More specifically, the optical collimator 21 is produced by inserting the partially spherical lens 23 having the translucent spherical surfaces 23b with approximately the same center of curvature at both end faces of the columnar portion 23a made of glass having an approximately uniform refractive index, and the concentric capillary tube 24 holding the optical fiber 25, into the inner hole 22a of the eccentric sleeve 22, wherein the center axis B of the outer surface and the center axis C of the inner hole 22a of the eccentric sleeve 22 are displaced from each other by δ in advance so that the optical axis Z of the collimated beam 27 will not be decentered with respect to the center axis A of the optical collimator 21, and then by fixing them at optically appropriate positions so that the optical collimator 21 perform correctly. So it is not necessary to conduct aligning work for bringing the decentered directions of the optical axes Z of entering/outgoing collimated beam 7 into coincidence at the time of assembling of the optical function component 8 or the like, as in the case of the conventional optical collimator 1 using the concentric sleeve 2 described above, it becomes possible to produce the optical collimator 21 with which the optical axis Z of the collimated beam 27 enters/outgoes with respect to the center axis A of the optical collimator 21. In addition, it becomes possible to produce the optical collimator 21 with which degradation of optical properties ascribable to differences in coefficient of thermal expansion among the eccentric sleeve 22, the partially spherical lens 23, and the capillary tube 24 at the time of use under various temperature conditions is minimized. Therefore, it becomes possible to produce an optical function component, various sensors, and the like having high reliability.

When one pair of the optical collimator 21 according to the present invention described above are arranged to oppose each other at positions, at which their working distance is secured, and under a state in which the center axes B of the outer surfaces of the eccentric sleeves 22 coincide with each other, and an optical signal is introduced from the optical fiber 25 on one side, an optical response of −30 dB or more is obtained with respect to an input from the optical fiber 25 on the other side. So it is not necessary to conduct cumbersome manual aligning work, it becomes possible to perform optical axis aligning of the pair of the optical collimators arranged to oppose each other with ease using an optical axis self-aligning apparatus or the like, and it becomes possible to assemble an optical device with unprecedented high efficiency.

In the optical collimator 21 according to the present invention, the eccentric sleeve 22 is made of glass or crystallized glass, so it becomes possible to achieve high-precision cylindricity and eccentricity amount (also referred to as the “off-axis amount”) with a drawing process and it also becomes possible to perform mass production with stability and with efficiency. In addition, the surface of the eccentric sleeve 22 is fire-polishe, which eliminates a necessity to polish the surface, so that an effect for producing at low cost is obtained.

In the optical collimator 21 according to the present invention, the capillary tube 24 is made of glass or crystallized glass, so it becomes possible to achieve high-precision cylindricity with a drawing process and its surface is fire-polished like in the case of the eccentric sleeve 22. Therefore, it is not necessary to polish the surface, so that an effect for producing with stability, with efficiency, and at low cost is obtained.

In the optical collimator 21 according to the present invention, differences in coefficient of thermal expansion among the eccentric sleeve 22, the partially spherical lens 23, and the capillary tube 24 are 50×10⁻⁷/K or less, so it becomes possible to minimize degradation of optical properties ascribable to the differences in coefficient of thermal expansion among the eccentric sleeve 22, the partially spherical lens 23, and the capillary tube 24. Thereby, the optical collimator 21 that is capable of maintaining stable performance with respect to changing of environmental temperature can be realized, which brings a practically superior effect.

In the optical collimator 21 according to the present invention, the partially spherical lens 23, the capillary tube 24, and the eccentric sleeve 22 are made of glass or crystallized glass as an electrically insulating material, sono influence of electromagnetic induction is exerted even in a high magnetic field of 1 Tesla or more, that is, 1000 Gauss or more. Therefore, the optical collimator 21 which will not be degraded in optical properties due to the electromagnetic induction can be realized.

It is generally known that light is not influenced by a static magnetic field in a vacuum but light reflected in a substance or on a surface of a substance is influenced by a magnetic field (magnetic flux in the substance). These phenomenons, in which the magnetic properties of the substance affect on polarization of light, are called “Faraday effect” and “magnetic Kerr effect”. However, the Faraday effect is a phenomenon, in which when linearly polarized light is caused to pass through a substance, a plane of polarization of light rotates with the strength of a magnetic field, and the magneticKerr effect is a phenomenon, in which when linearly polarized light enters a substance, elliptically polarized light, whose principal axis direction is inclined from the direction of the incident linearly polarized light, is reflected. Thus, since these effects affect only on polarization of light, these effects do not cause any problems with optical properties in application to various sensors adopting a system, in which a rotary encoder or the like is attached to a rotation axis and an optical pulse of the rotary encoder or the like that detects a movement of the rotation axis is detected.

Also, the maximum diameter of the optical collimator 21 according to the present invention is preferable to be less than 2 mm, more preferable to be less than 1.5 mm.

When the maximum diameter of the optical collimator 21 according to the present invention, such as the outer diameter of the eccentric sleeve 22, is less than 2 mm, miniaturization of an optical device using the optical collimator 21 and high-density arrangement of the optical collimators 21 become possible.

### BRIEF DESCRIPTION OF THE DRAWINGS

FIG. 1 is an explanatory diagram of an optical collimator according to the present invention, with FIG. 1(A) being a cross-sectional view in a direction parallel to an optical axis, FIG. 1(B) being a cross-sectional view in a direction vertical to the optical axis, and FIG. 1(C) being an explanatory diagram of performance evaluation in which optical collimators are set to oppose each other on a V-groove.

FIG. 2 is an explanatory diagram of a capillary tube that is used for the optical collimator according to the present invention and holds an optical fiber, with FIG. 2(A) being a cross-sectional view in the direction parallel to the optical axis and FIG. 2(B) being a cross-sectional view in the direction vertical to the optical axis.

FIG. 3 is an explanatory diagram of a partially spherical lens used for the optical collimator according to the present invention, with FIG. 3(A) being a crossed-sectional view in the direction parallel to the optical axis and FIG. 3(B) being a cross-sectional view in the direction vertical to the optical axis.

FIG. 4 is an explanatory diagram of an eccentric sleeve used for the optical collimator according to the present invention, with FIG. 4(A) being a cross-sectional view in the direction parallel to the optical axis and FIG. 4(B) being a cross-sectional view in the direction vertical to the optical axis.

FIG. 5 is an explanatory diagram of the optical collimator according to the present invention that has a long working distance, with FIG. 5(A) being a cross-sectional view in the direction parallel to the optical axis and FIG. 5(B) being a cross-sectional view in the direction vertical to the optical axis.

FIG. 6 is an explanatory diagram of a rotary encoder using optical collimators.

FIG. 7 is an explanatory diagram of a rotary encoder that uses optical collimators and is capable of detecting a rotation direction.

FIG. 8 is an explanatory diagram of α-phase and β-phase signal processing by the rotary encoder.

FIG. 9 is an explanatory diagram of a conventional optical collimator, with FIG. 9(A) being a cross-sectional view in a direction parallel to an optical axis and FIG. 9(B) being a cross-sectional view in a direction vertical to the optical axis.

FIG. 10 is a cross-sectional view of an optical function component using the conventional optical collimators.

FIG. 11 is a cross-sectional view of an optical collimator in the case where an optical fiber end face is not angled polished.

### BEST MODE FOR CARRYING OUT THE INVENTION

Embodiments of the present invention will be described with reference to the drawings.

### First Embodiment

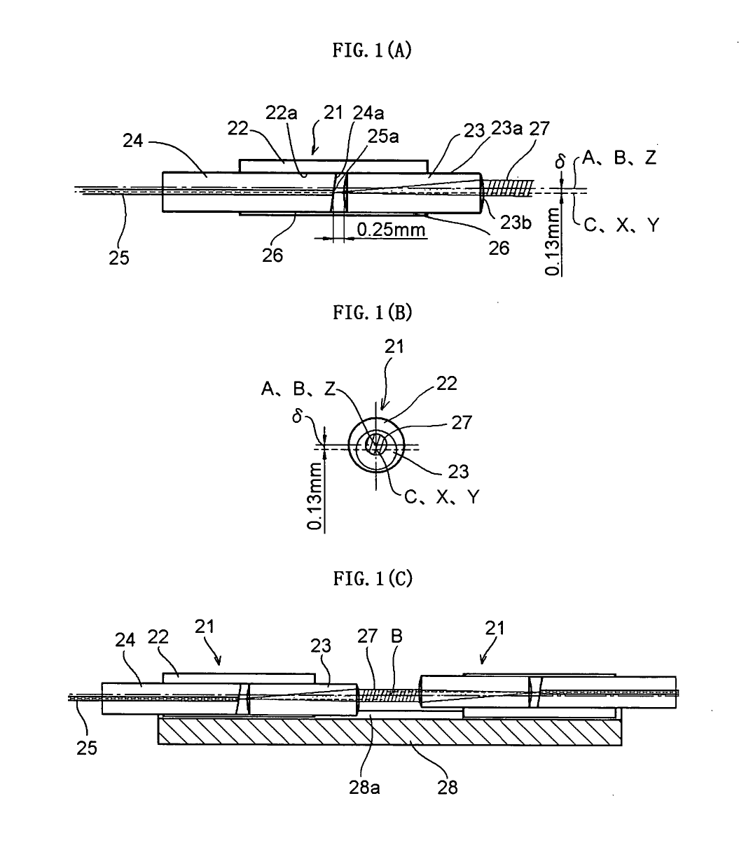

FIG. 1 is an explanatory diagram of an optical collimator 21 that is an example of the present invention. In the drawing, reference numeral 22 denotes a glass-made eccentric tube serving as an eccentric sleeve; 23, a partially spherical lens; 26, an adhesive; 24, a concentrically structured capillary tube; and 25, an optical fiber.

When the refractive index of the core portion of the optical fiber 25 is referred to as “n₁”, the refractive index of the air in an in-the-atmosphere case is referred to as “n₂”, the refractive index of the partially spherical lens 23 is referred to as 37 n₃”, the radius of curvature of the partially spherical lens 23 is referred to as “r”, and the angled polished angle of an end face 25a of the optical fiber 25 is referred to as “θ”, an amount δ, by which the eccentric sleeve 22 constituting the optical collimator 21 in FIG. 1 is decentered in advance, is expressed as follows.

$$δ = \frac{{n}_{3}}{2 ( {n}_{3} - {n}_{2} )} \cdot r \cdot tan [ \{ arcsin ( \frac{{n}_{1}}{{n}_{2}} sin θ ) \} - θ ] \qquad [ Expression 1 ]$$

Table 1 shows an example of each parameter of the optical collimator 21 that uses optical glass “LaSF015” as the glass material of the partially spherical lens 23.

TABLE 1

| Item | Value |
|---|---|
| n₁ | 1.4492 |
| n₂ | 1.0 |
| n₃ | 1.7753 |
| r | 1.75 mm |
| θ | 8.0° |

When calculated from Expression 1 using each parameter described above, the eccentricity amount δ becomes 0.13 mm. Therefore, it is sufficient that the eccentricity amount δ of the eccentric sleeve 22 used for the optical collimator 21 having the structure shown in FIG. 1 is set to 0.13 mm in the case of the parameters shown in Table 1.

As shown in FIG. 1 (A), (B), the optical collimator 21 according to the present invention includes: the glass-made eccentric sleeve 22 which has outer diameter of 1.4 mm, inner hole diameter of 1.0 mm, eccentricity amount δ (off-axis amount) of 0.13 mm between an outer surface center axis B and an inner hole center axis C, and overall length of 5.0 mm; the partially spherical lens 23 that is fixed to an inner hole 22a of the eccentric sleeve 22, is made of optical glass “LaSF015” having an approximately uniform refractive index, has translucent spherical surfaces 23b with approximately the same center of curvature at both ends of a columnar portion 23a, and has a radius of curvature r of 1.75 mm; and the adhesive 26 that is made of an epoxy-based resin and bonds the partially spherical lens 23 to the inner hole 22a of the eccentric sleeve 22. In order to reduce optical signal reflection, not-shown antireflection coating is formed for the translucent spherical surfaces 23b of the partially spherical lens 23. Also, in order to reduce reflection return optical signal from the end face 25a of the held optical fiber 25, the concentric capillary tube 24, which has outer diameter of 1.0 mm and overall length of 4.3 mm, is angled polished at 8° with respect to a plane vertical to the center axis Y of the outer surface of the capillary tube 24, and a not-shown entire election coating is formed for the end face 25a. In addition, the adhesive 26 is provided which is made of an epoxy-based resin and bonds the concentric capillary tube 24 to the inner hole 22a of the eccentric sleeve 22.

In the optical collimator 21 according to the present invention, the end face 25a of the optical fiber 25 and the translucent spherical surface 23b of the partially spherical lens 23 are fixed using the adhesive 26 made of an epoxy-based resin at positions at which an optically appropriate distance of 0.25 mm is secured so that the optical collimator 21 perform correctly.

Next, Table 2 shows examples of the insertion loss of the optical collimator 21, a return loss, the outgoing deviation angle of collimated beam 27 (beam inclination angle), and the eccentricity amount of the optical axis Z of the collimated beam 27 with respect to the center axis A of the optical collimator 21 (optical axis eccentricity).

TABLE 2

| | | | Optical axis |
|---|---|---|---|
| | | Outgoing | eccentricity of |
| Insertion loss | Return loss | deviation angle | collimated beam |
| 0.2 dB or less | 60 dB or more | 0.1° or less | 0.015 mm or less |

Light having a wavelength of 1550 nm is used for measuring these values and the insertion loss is measured under a state where two optical collimators 21 are arranged to oppose each other so that the working distance becomes 17.5 mm. Here, the working distance means a spatial distance between the external translucent spherical surfaces 23b of the partially spherical lenses 23 of the optical collimators 21 arranged to oppose each other.

As shown in Table 2, as to the insertion loss and the return loss, performance that is equal to or better than that in a conventional case is exhibited and there is no practical problem.

Also, the outgoing deviation angle assumes a value of 0.1° or less that is an extremely favorable value as compared with the conventional case. Further, the eccentricity amount of the optical axis Z of the collimated beam 27 with respect to the center axis A of the optical collimator 21 assumes a value of 0.015 mm or less. Thus, for instance, when the optical collimators 21 are placed to oppose each other on a V-groove 28a of a V-groove substrate 28 at positions as shown in FIG. 1(C), at which their working distance is secured, and under a state, in which the center axes B of the outer surfaces of the eccentric sleeves 22 coincide with each other, an optical signal response is obtained even under a non-aligned state. So when an optical function component, for which it is required to conduct optical collimator aligning work, is assembled using a automatic aligning apparatus or the like, working efficiency is significantly improved as compared with the conventional case. Insertion loss measurement was conducted using light having a wavelength of, for instance, 1550 nm under a non-aligned state in which two optical collimators 21 were arranged to oppose each other on one V-groove with a working distance of 17.5 mm. The value of the insertion loss in this case was around 1.5 dB.

Measurement was conducted as to an optical signal response of −30 dB or more, with which a automatic aligning apparatus operates, merely under a non-aligned state in which the optical collimators were placed on one V-groove in the manner described above. That is, measurement was conducted for various optical systems using such an optical system. As a result, optical signal responses of −10 dB or more were obtained for most of the optical systems and in the case of ordinarily worked optical systems, sufficient optical signal responses in a range from −5 dB to −1 dB were obtained with respect to input signals. As described above, it is possible to obtain sufficient optical signal responses with ease, so unprecedented performance is exhibited.

Next, a method of assembling the optical collimator 21 will be described.

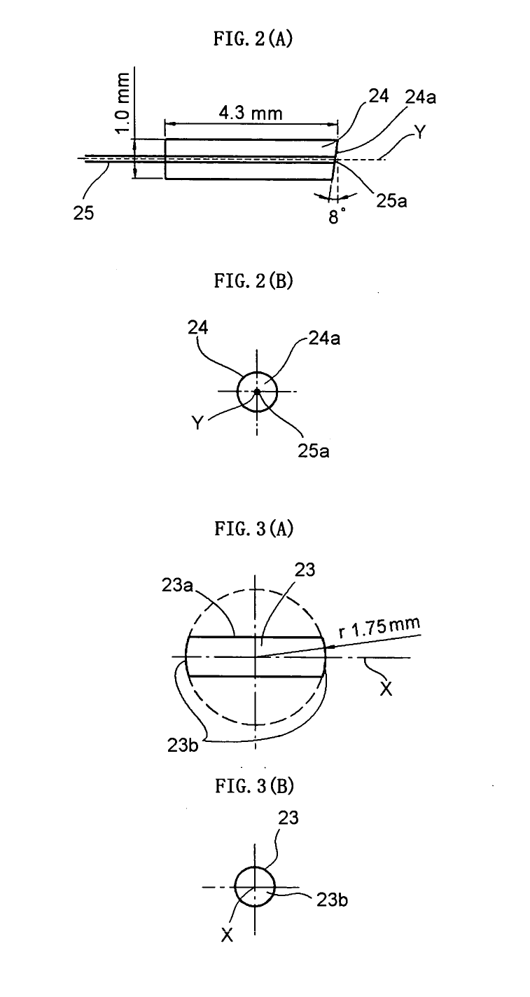

First, a long capillary tube, which has outer diameter of less than 1.0 mm and inner diameter of slightly larger than the diameter of the optical fiber 25, is produced by, for instance, re-heat/re-drawing a base material having a similar shape. Next, the long capillary tube is cut into an appropriate length, and then the optical fiber 25 is inserted/bonded to the inner hole of the capillary tube 24 as shown in FIG. 2. After, the capillary tube 24 and the optical fiber 25 are angled polished at 8° with respect to a plane vertical to the outer surface center axis Y of the capillary tube 24, and then a not-shown antireflection coating film is formed on the end face 25a of the optical fiber 25. In this manner, the capillary tube 24 is produced, which has outer diameter of less than 1.0 mm and overall length of 4.3 mm, and outer surface center axis Y of which becomes the optical axis. Note that for the outer surface of the capillary tube 24, a marking or an orientation flat worked portion (not shown) is formed which indicates the direction of the 8° angled polishing performed on the end face 25a of the optical fiber 25.

Also, a spherical lens indicated by a broken line in FIG. 3 that has high sphericity and is available at a low price is used as a material and is ground into a columnar shape using a not-shown grinding machine. In this manner, the partially spherical lens 23 is produced, which has the diameter of less than 1.0 mm, and the translucent spherical surfaces 23b with the same center of curvature and a radius of curvature r of 1.75 mm at both ends of the columnar portion 23a made of glass having approximately uniform refractive index, and outer surface center axis X of which becomes the optical axis.

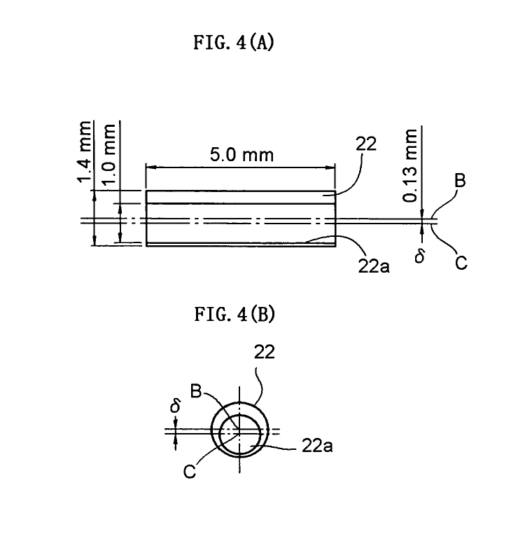

Next, the transparent glass-made eccentric sleeve 22 shown in FIG. 4, which has eccentricity amount δ of 0.13 mm between the outer surface center axis B and the inner hole center axis C, outer diameter of 1.4 mm, and inner hole diameter of 1.0 mm, is produced by, for instance, re-heat/re-drawing a base material having a similar shape. When a marking or an orientation flat worked portion (not shown) for registration of the decentered direction of the outer surface center axis B of the eccentric sleeve 22 and the inner hole center axis C of the eccentric sleeve 22 is formed for the outer surface of the eccentric sleeve 22, assembling of the optical collimator 21 is facilitated.

Next, the partially spherical lens 23 is fixed into the inner hole 22a of the eccentric sleeve 22 and is bonded using the adhesive 26. After the adhesive 26 is completely cured, the capillary tube 24 is inserted and is positioned with reference to the markings. Then, positioning at a position, at which a distance between the end face 25a of the optical fiber 25 and the translucent spherical surface 23b of the partially spherical lens 23 becomes 0.25 mm, is performed while performing observation/measurement and fixation and bonding are performed using the adhesive 26. In this method, the optical collimator 21 shown in FIG. 1 is obtained with which the center axis B of the outer surface of the eccentric sleeve 22 becomes the optical axis Z of the collimated beam 27.

### Second Embodiment

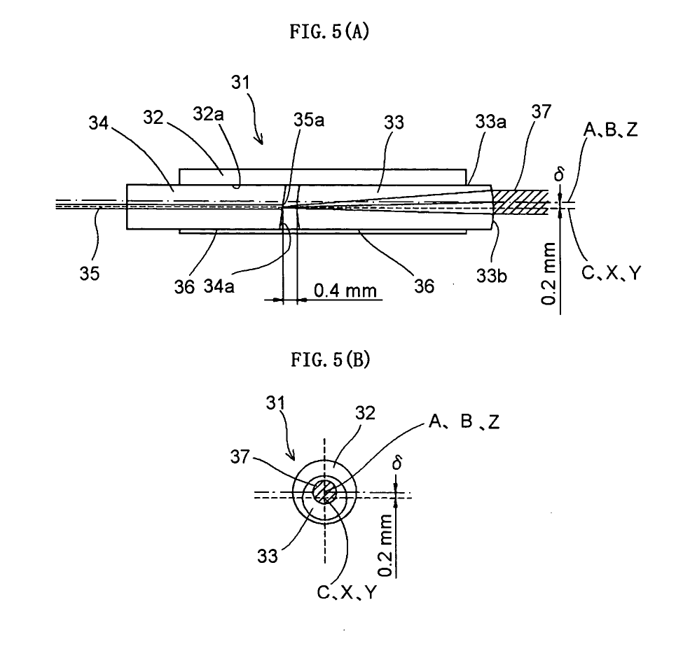

FIG. 5 is an explanatory diagram of an optical collimator 31 that is another example of the present invention and has a long working distance. In the drawing, reference numeral 32 denotes a glass-made tube serving as an eccentric sleeve; 33, a partially spherical lens; 36, an adhesive; 34, a capillary tube; and 35, an optical fiber. This example is a case where a glass-made tube is used as the eccentric sleeve 32, but another material may be used instead so long as the mutual differences in coefficient of thermal expansion are 50×10⁻⁷/K or less.

When the refractive index of the core portion of the optical fiber 35 is referred to as “n₁”, the refractive index of the air in an in-the-atmosphere case is referred to as “n₂”, the refractive index of the partially spherical lens 33 is referred to as “n₃”, the radius of curvature of the partially spherical lens 33 is referred to as “r”, and the angled polished angle of the end face 35a of the optical fiber 35 is referred to as “θ”, an eccentricity amount δ, by which the center axis B of the outer surface of the eccentric sleeve 32 constituting the optical collimator 31 in FIG. 5 and the center axis C of an inner hole 32a of the eccentric sleeve 32 are displaced from each other in advance, becomes as expressed by Expression 1 described above.

Table 3 shows an example of each parameter of the optical collimator 31 that uses optical glass “LaSF015” as the glass material of the partially spherical lens 33 and has a long working distance.

TABLE 3

| Item | Value |
|---|---|
| n₁ | 1.4492 |
| n₂ | 1.0 |
| n₃ | 1.7753 |
| r | 2.75 mm |
| θ | 8.0° |

When calculated from Expression 1 using each parameter described above, the eccentricity amount δ is 0.20 mm. Therefore, in the case of the parameters shown in Table 3, it is sufficient that the eccentricity amount between the outer surface center axis B of the eccentric sleeve 32 used for the optical collimator 31 having the structure shown in FIG. 5 and a long working distance and the inner hole center axis C of the eccentric sleeve 32 is set to 0.02 mm.

The optical collimator 31 according to the present invention having a long working distance includes: the glass-made tube serving as the eccentric sleeve 32 which has outer diameter of 1.8 mm, inner hole diameter of 1.25 mm, overall length of 8.0 mm, and eccentricity amount δ of 0.20 mm between the outer surface center axis B and the inner hole center axis C; the partially spherical lens 33 that is fixed into the inner hole 32a of the eccentric sleeve 32, is made of optical glass “LaSF015” having an approximately uniform refractive index, and has translucent spherical surfaces 33b with approximately the same center of curvature at both ends of a columnar portion 33a; and the adhesive 36 made of an epoxy-based resin and bonding the partially spherical lens 33 to the inner hole 32a of the eccentric sleeve 32. In order to reduce optical signal reflection, not-shown entire election coating is formed for the translucent spherical surfaces 33b of the partially spherical lens 33. Also, in order to reduce reflection optical signal from an end face 35a of the held optical fiber 35, the capillary tube 34, which has outer diameter of 1.25 mm and overall length of 4.3 mm, is angled polished at 8° with respect to a plane vertical to the center axis Y of the outer surface of the capillary tube 34 and a not-shown antireflection coating is formed for the end face 35a. In addition, the adhesive 36 is provided which is made of an epoxy-based resin and bonds the capillary tube 34 to the inner hole 32a of the eccentric sleeve 32.

In the optical collimator 31 according to the present invention having a long working distance, the end face 35a of the optical fiber 35 and the translucent spherical surface 33b of the partially spherical lens 33 are fixed at positions, at which optically appropriate distance of 0.40 mm is secured so that the optical collimator operates correctly, using the adhesive 36 made of an epoxy-based resin.

Next, Table 4 shows examples of the insertion loss of the optical collimator 31 having a long working distance, a return loss, the outgoing deviation angle of the collimated beam 37 (also referred to as “beam inclination angle”), and the eccentricity amount of the optical axis Z of the collimated beam 37 with respect to the center axis A of the optical collimator 31 having a long working distance (also referred to as “optical axis eccentricity”).

TABLE 4

| | | | Optical axis |
|---|---|---|---|
| | | Outgoing | eccentricity of |
| Insertion loss | Return loss | deviation angle | collimated beam |
| 0.3 dB or less | 60 dB or more | 0.1° or less | 0.015 mm or less |

Light having a wavelength of 1550 nm is used for measuring these values and the insertion loss is measured under a state where two optical collimators 31 having a long working distance are arranged to oppose each other so that the working distance becomes 150 mm.

As to the insertion loss and the return loss, performance that is equal to or better than that in a conventional case is exhibited and there is no practical problem.

Also, the outgoing deviation angle assumes a value of 0.1° or less that is an extremely favorable value as compared with a case of a conventional optical collimator having a long working distance. Further, the eccentricity amount of the optical axis Z of the collimated beam 37 with respect to the center axis A of the optical collimator 31 having a long working distance assumes a value of 0.015 mm or less. Thus, for instance, when the optical collimators 31 having a long working distance are placed to oppose each other on a precise V-groove at positions, at which a predetermined working distance is secured, and under a state, in which the center axes B of the outer surfaces of the eccentric sleeves 32 coincide with each other, as shown in FIG. 1(C) described above, an optical signal response is obtained with an insertion loss of around several dB with respect to an input even under a non-aligned state. So when an optical function component, for which it is required to conduct work for aligning the optical collimators 31 having a long working distance, assembled using a automatic aligning apparatus or the like, working efficiency is significantly improved as compared with the case of the conventional optical collimator having a long working distance.

Insertion loss measurement was actually conducted using light having a wavelength of 1550 nm under a non-aligned state in which two optical collimators 31 were arranged to oppose each other on a V-groove with a working distance of 150 mm. In this case, an optical signal response was obtained with an insertion loss of around 1.5 dB with respect to an input and unprecedented performance was exhibited.

In addition, in spite of the fact that the optical collimator 31 according to the present invention shown in FIG. 5 has a long working distance of 150 mm, the optical collimator 31 that has an outer diameter of 1.8 mm and superior optical properties is realized by reducing the diameter of the outer surface of the partially spherical lens 33 to 1.25 mm.

### Third Embodiment

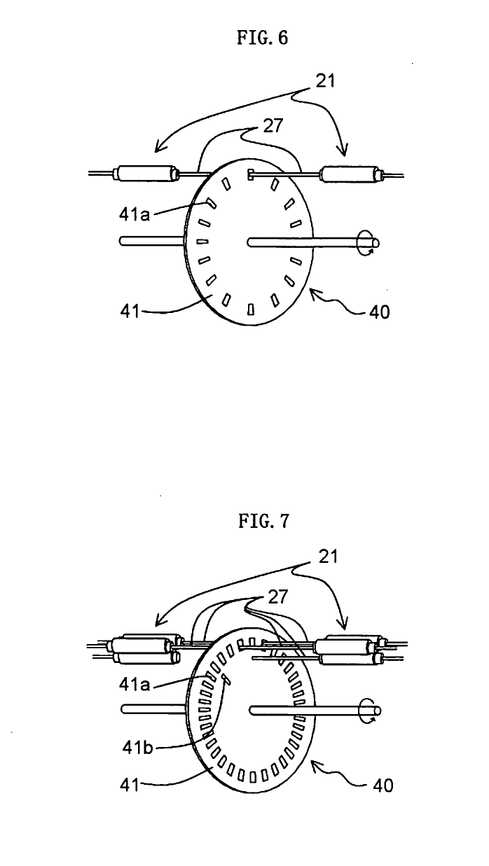

FIG. 6 is an explanatory diagram showing an example of an incremental-type rotary encoder 40 that uses the optical collimator 21 according to the present invention. The rotary encoder 40 is one kind of sensors, which detect rotation angles and rotation angular velocities. In the rotary encoder 40, a scale 41 having signal slits 41a is directly attached to a rotation axis as shown in FIG. 6, and a rotation angle is detected with reference to a pulse signal of collimated beam 27 of the optical collimators 21 passing through the signal slits 41a. It is also possible to detect a rotation angular velocity by differentiating the obtained rotation angle with respect to time.

With the structure shown in FIG. 6, however, although it is possible to detect the rotation angle, it is impossible to detect a rotation direction. Therefore, in many rotary encoders, the rotation direction is detected and a start point is also detected by using multiple optical collimators 21. By using three pairs of (In total, six pieces) optical collimators 21 at the minimum as shown in FIG. 7, it becomes possible to detect the rotation direction and the start point.

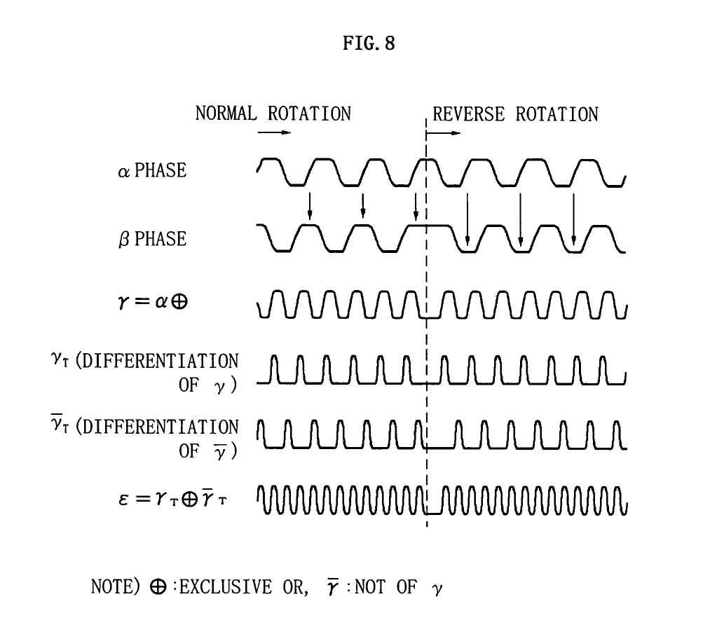

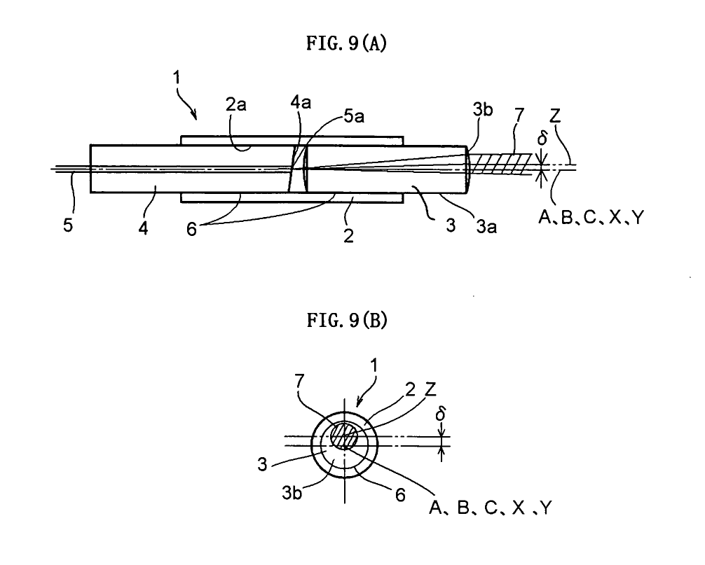

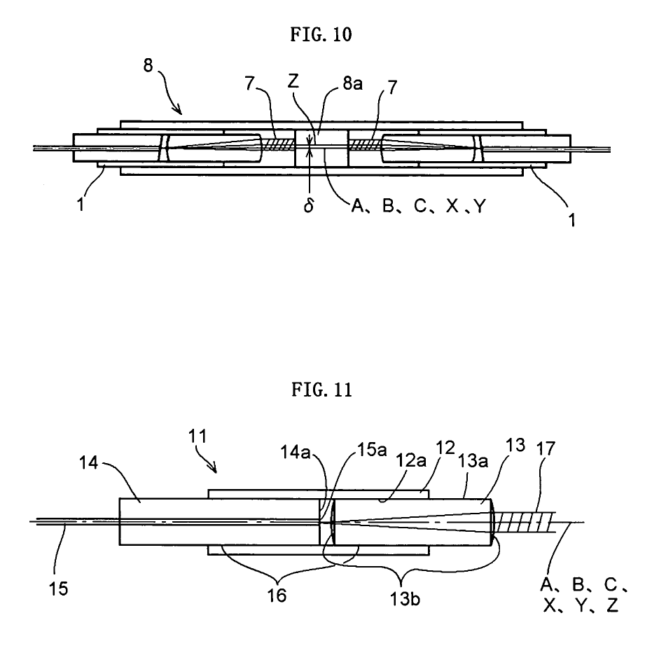

A pulse signal detected from the optical collimator 21 on a light reception side in FIG. 7 and processing of the signal are shown in FIG. 8. An α phase and a β phase are arranged so that they are detected with a phase shift of 180°, but the resolution of the rotation angle is coarse under this state, so the resolution may be doubled by exclusive-ORing an α-phase pulse signal and a β-phase pulse signal.

The exclusive OR means a computation in which the incremental-type rotary encoder 40 using the optical collimators 21 according to the present invention outputs an ON-signal when the inputs of the α-phase pulse signal and the β-phase pulse signal are different from each other and outputs an OFF-signal otherwise. Table 5 shows processing results that of the exclusive-ORing of the α-phase pulse signal and the β-phase pulse signal.

TABLE 5

| | | Exclusive or γ |
|---|---|---|
| α-phase signal | β-phase signal | signal |
| OFF | OFF | OFF |
| OFF | ON | ON |
| ON | OFF | ON |
| ON | ON | OFF |

In addition, it is possible to quadruple the resolution of the rotation angle by exclusive-ORing a result of differentiation of the exclusive OR of the α-phase pulse signal and the β-phase pulse signal and a result of differentiation of NOT of the exclusive OR of the α-phase pulse signal and the β-phase pulse signal.

When it is desired to judge whether the rotation axis makes normal rotation or reverse rotation with the incremental-type rotary encoder 40 shown in FIG. 7 that uses the optical collimators 21 according to the present invention, it is possible to make the judgment by detecting whether the β-phase signal is ON or OFF at the time of rising of the α-phase pulse signal.

The incremental-type rotary encoder 40 shown in FIG. 7 is often used in industrial robots and the like. The optical collimator 21 according to the present invention is produced using the partially spherical lens 23, the capillary tube 24, the eccentric sleeve 22, and the optical fiber 25 made of glass or crystallized glass as an electrically insulating material and no metallic member is used, so that no influence of electromagnetic induction is exerted even in a high magnetic field of 1 Tesla or more, that is, 10000 Gauss or more, which enables usage even in an ultra-high magnetic field using a superconducting magnet such as an MRI (magnetic resonance imaging).

When the scale 41 and the rotation axis shown in FIG. 7 are produced using non-metals such as resins or glass, it becomes possible to realize the incremental-type rotary encoder 40 constructed using only non-metallic materials, which makes it possible to use the incremental-type rotary encoder 40 without being influenced by electromagnetic induction even in a device that is exposed to a high magnetic field.

The incremental-type rotary encoder 40 shown in FIG. 7 is constructed using the optical collimator 21 according to the present invention and it is possible to transmit an obtained pulse signal to a pulse signal processing device installed at a remote place, at which no influence of a high magnetic field is exerted, through the electrically insulating optical fiber 25 at a low loss.

It is generally known that light is not influenced by a static magnetic field in a vacuum but light reflected in a substance or on a surface of a substance is influenced by a magnetic field (magnetic flux in the substance). These phenomenons, in which the magnetic properties of the substance affect on polarization of light, are called “Faraday effect” and “magnetic Kerr effect”. However, the Faraday effect is a phenomenon, in which when linearly polarized light is caused to pass through a substance, a plane of polarization of light rotates with the strength of a magnetic field, and the magnetic Kerr effect is a phenomenon, in which when linearly polarized light enters a substance, elliptically polarized light, whose principal axis direction is inclined from the direction of the incident linearly polarized light, is reflected. Thus, since these effects affect only on polarization of light, these effects do not cause any problems with optical properties in application to various sensors adopting a system, in which a rotary encoder 40 or the like is attached to a rotation axis and an optical pulse of the rotary encoder or the like that detects a movement of the rotation axis is detected.

The third embodiment has been described using the optical collimator 21, but, as a matter of course, the incremental-type rotary encoder 40 may be constructed using the optical collimator 31 of the second embodiment that has a long working distance.

1. An optical collimator, comprising:
a cylindrical eccentric sleeve;
a partially spherical lens having a columnar portion fixed into the eccentric sleeve and translucent spherical surfaces with approximately the same center of curvature at both ends of the columnar portion; and
a capillary tube fixed into the eccentric sleeve, holding an optical fiber at a center, and having an angled end face directed toward the partially spherical lens,
wherein the eccentric sleeve is made of glass or crystallized glass.

2. An optical collimator according to claim 1, wherein an optical axis of collimated beam outgoing from the translucent spherical surface of the partially spherical lens is in a round with radius range of 0.02 mm or less, the center of the round being a center axis of an outer surface of the sleeve, and in an angle range of 0.220 or less with respect to the center axis of the outer surface of the sleeve.

3. An optical collimator according to claim 1, wherein, when one pair of the optical collimators are arranged to oppose each other at positions, at which a working distance thereof is secured, and under a state, in which the center axes of the outer surfaces of the eccentric sleeves coincide with each other, and when optical signal is introduced from the optical fiber on one side, an optical signal response of −30 dB or more is obtained with respect to an input from the optical fiber on the other side.

4. An optical collimator according to claim 1, wherein the eccentric sleeve is produced using a drawing process.

5. An optical collimator according to claim 1, wherein the capillary tube is made of glass or crystallized glass.

6. An optical collimator according to claim 1, wherein differences in coefficient of thermal expansion among the partially spherical lens, the capillary tube, and the eccentric sleeve are 50×10⁻⁷/K or less.

7. An optical collimator according to claim 5, wherein the partially spherical lens is made of glass or crystallized glass as an electrically insulating material and substantially no eddy current is generated due to electromagnetic induction in a high magnetic field of 1 Tesla or more.

8. An optical collimator according to claim 1, wherein a maximum diameter is less than 2 mm.

9. An optical collimator according to claim 2, wherein, when one pair of the optical collimators are arranged to oppose each other at positions, at which a working distance thereof is secured, and under a state, in which the center axes of the outer surfaces of the eccentric sleeves coincide with each other, and when optical signal is introduced from the optical fiber on one side, an optical signal response of −30 dB or more is obtained with respect to an input from the optical fiber on the other side.

10. An optical collimator according to claim 6, wherein the partially spherical lens is made of glass or crystallized glass as an electrically insulating material and substantially no eddy current is generated due to electromagnetic induction in a high magnetic field of 1 Tesla or more.
